(19) United States
(12) Patent Application Publication
(10) Pub. No.: US 2020/0187328 A1
(43) Pub. Date: Jun. 11, 2020

(54) SWITCHING POWER SUPPLY AND TELEVISION

(71) Applicant: SHENZHEN SKYWORTH-RGB ELECTRONIC CO., LTD., Shenzhen, Guangdong (CN)

(72) Inventors: Jianzhong Chen, Shenzhen, Guangdong (CN); Jitao Yang, Shenzhen, Guangdong (CN)

(21) Appl. No.: 16/313,049

(22) PCT Filed: Jan. 5, 2017
(86) PCT No.: PCT/CN2017/070308

§ 371 Date: Dec. 23, 2018

(30) Foreign Application Priority Data
Sep. 9, 2016 (CN) 201610814008.0

(51) Int. Cl. H05B 45/382; H05B 45/355; H05B 45/345; H05B 45/10; H05B 45/36; H02M 1/42; H02M 3/335; H05B 45/46; H02M 1/44; H04N 5/63

(52) U.S. Cl. CPC H05B 45/382; H05B 45/355; H05B 45/345; H05B 45/10; H04N 5/63; H02M 1/4258; H02M 3/33523; H05B 45/46; H02M 1/44; H05B 45/36

(57) ABSTRACT

The present disclosure discloses a switching power supply and a television. The switching power supply includes a constant-current switch circuit, a first single stage PFC circuit, a first transformer, a constant-current feedback circuit, a constant-voltage switch circuit, a second single stage PFC circuit and a second transformer; the constant-current feedback circuit samples a current outputted by the first transformer, and feeds back the sampled current to the first single stage PFC circuit; the first single stage PFC circuit outputs a switch signal, and drive the constant-current switch circuit to be turned on or off, so as to control a load current to be constant according to the sampled current; the second single stage PFC circuit outputs a switch signal and drive the constant-current switch circuit to be turned on or off.

### TECHNICAL FIELD

The present disclosure relates to the field of power supply technology, and in particular, to a switching power supply and a television having the switching power supply.

### BACKGROUND

When power demand of a load is higher than 75 W, a power factor needs to be higher than 0.9 due to the national standards. A traditional television power supply architecture is shown in FIG. 1, the power supply needs to be performed a power factor correction (PFC) first, and then carried out DC-DC conversion, then a 24V outputted by the constant-voltage output power supply needs to be boosted of voltage to supply power to backlight light bars, which would result in a low power conversion efficiency, and increased costs of constant-current board and PFC circuit. Meanwhile, the power supply architecture outputs constant-current and constant-voltage alternately, which is prone to be interfered when dynamic load being applied to the constant-voltage and the constant-current.

### SUMMARY

It is therefore one primary object of the present disclosure to provide a switching power supply, intending to improve the power conversion efficiency, increase the stability of outputting constant-voltage and constant-current, and reduce the cost of power supply.

To achieve the above object, the present disclosure provides a switching power supply which includes a constant-current switch circuit, a first single stage PFC circuit, a first transformer, and a constant-current feedback circuit, and further includes a constant-voltage switch circuit, a second single stage PFC circuit and a second transformer; in which

the constant-current feedback circuit samples a current outputted by the first transformer, and feeds back the sampled current to the first single stage PFC circuit;

the first single stage PFC circuit outputs a switch signal, drives the constant-current switch circuit to be turned on or off, and controls the load current to be constant according to the sampled current; and

the second single stage PFC circuit outputs a switch signal and drives the constant-current switch circuit to be turned on or off; the second single stage PFC circuit samples a voltage outputted by the second transformer to obtain the sampled voltage, and regulate a duty ratio of the switch signal according to the sampled voltage, to regulate the voltage output to the main board, to control the voltage of the load to be constant.

Preferably, the switching power supply further includes a constant-current switch and a constant-current control circuit, in which the load is LED light bars,

the constant-current switch adjusts the brightness of the LED light bars according to a PWM brightness signal outputted by the main board; and

the constant-current control circuit controls the LED light bars to be illuminated or extinguished according to an enable signal outputted by the main board.

Preferably, the constant-current control circuit controls current flowing through each LED light bar to be same during the LED light bars are in a working status.

Preferably, an input terminal of the constant-current circuit receives direct current, an output terminal of the constant-current switch circuit is coupled to an output terminal of the first transformer; a sample terminal of the first transformer is coupled to a zero current detection terminal of the first single stage PFC circuit; the output terminal of the first transformer is coupled to input terminals of the LED light bars, output terminals of the LED light bars coupled to an input terminal of the constant-current switch, a controlled terminal of the constant-current switch is coupled to the main board, an output terminal of the constant-current switch is coupled to an input terminal of the constant current control circuit; an output terminal of the constant-current control circuit is coupled to an input terminal of the constant feedback circuit, an controlled terminal of the constant-current control circuit receives the enable signal inputted by the main board; an output terminal of the constant-current feedback circuit is coupled to a feedback terminal of the first single stage PFC circuit;

the input terminal of the constant-current switch circuit receives direct current, an output terminal of the constant-voltage circuit is coupled to an input terminal of the second transformer, a sampled terminal of the second transformer is coupled to a zero current detection terminal of the second single stage PFC circuit; an output terminal of the second transformer is electrically coupled to the main board.

Preferably, the constant-current feedback circuit turns off the first single stage PFC circuit detecting the LED light bar is not in a working status.

Preferably, the switching power supply further includes a DC-DC conversion circuit, an input terminal of the DC-DC conversion circuit is coupled to an output terminal of the second transformer, an output terminal of the DC-DC conversion circuit is electrically coupled to the main board.

Preferably, the constant-current control circuit includes a starting circuit, a constant-current reference source circuit, and a plurality of mirror constant-current circuits; an output terminal of the starting circuit is coupled to the main board to receive the enable signal; an output terminal of the starting circuit is coupled to a controlled terminal of the constant-current reference source circuit, an input terminal of the constant-current reference source circuit is coupled to an output terminal of one of the LED light bars; all controlled terminals of the mirror constant-current circuits is coupled to an output terminal of the constant-current reference source circuit, input terminals of the mirror constant-current circuits are coupled to output terminals of other LED light bars respectively.

Preferably, the starting circuit includes an eleventh resistor, a twelfth resistor, a thirteenth resistor, a fourth triode, a fifth triode;

a first terminal of the eleventh resistor is coupled to a direct current power supply, a second terminal of the eleventh resistor is coupled to an emitter of the fourth triode, a collector of the fourth triode is coupled to the controlled terminal of the constant-current reference source circuit, a base of the fourth triode is coupled to a collector of the fifth triode via the twelfth resistor, an emitter of the fifth triode is grounded, a base of the fifth triode is coupled to the main board via the thirteenth resistor, to receive the enable signal of the main board.

Preferably, the constant-current reference source circuit includes a fourteenth resistor a second voltage reference chip, a sixth triode; an input terminal of the second voltage reference chip is coupled to a collector of the fourth triode, an output terminal of the second voltage reference chip is grounded; a reference terminal of the second voltage reference chip is coupled to controlled terminals of the mirror constant-current circuits, and the reference terminal of the second voltage reference chip also coupled to a base of the sixth triode, the base of the sixth triode also coupled to the collector of the fourth triode, a collector of the sixth triode is coupled to input terminals of the LED light bars, an emitter of the sixth triode is grounded via the fourteenth transistor.

The mirror constant-current circuit comprises a fifteenth resistor, a seventh triode; a collector of the seventh triode is coupled to an output terminal of another LED light bar, an emitter of the seventh triode is grounded via the fifteenth resistor.

Preferably, the switching power supply further includes over-voltage regulation circuits, in which the number of the over-voltage regulation circuits corresponds to the number of the LED light bars; each input terminal of the over-voltage regulation circuits is coupled to a corresponding output terminal of the constant-current switch, all output terminals of the over-voltage regulation circuits are coupled to a regulation terminal of the constant-current feedback circuit.

Preferably, the switching power supply further includes a first secondary rectifier and filter circuit and a second secondary rectifier and filter circuit; the first secondary rectifier and filter circuit rectifies and filters a pulsating direct current outputted by the first transformer; the second secondary rectifier and filter circuit rectifies and filters a pulsating direct current power outputted by the second transformer.

The present disclosure also provides a television including LED light bars and a main board, and further including the switching power supply described previously; the switching power supply being electrically coupled to the LED light bars and the main board respectively, the main board being electrically coupled to the LED light bars.

Preferably, the switching power supply further includes a constant-current switch and a constant-current control circuit, in which the load is LED light bars,

the constant-current switch adjusts the brightness of the LED light bars according to a PWM brightness signal outputted by the main board; and

the constant-current control circuit controls the LED light bars to be illuminated or extinguished according to an enable signal outputted by the main board.

Preferably, the constant-current control circuit controls current flowing through each LED light bar to be same during the LED light bars are in a working status.

Preferably, the input terminal of the constant-current circuit receives direct current, the output terminal of the constant-current switch circuit is coupled to the output input terminal of the first transformer; the sample terminal of the first transformer is coupled to the zero current detection terminal of the first single stage PFC circuit; the output terminal of the first transformer is coupled to input terminals of the LED light bars, output terminals of the LED light bars coupled to the input terminal of the constant-current switch, the controlled terminal of the constant-current switch is coupled to the main board, the output terminal of the constant-current switch is coupled to the input terminal of the constant current control circuit; the output terminal of the constant-current control circuit is coupled to the input terminal of the constant feedback circuit, the controlled terminal of the constant-current control circuit receives the enable signal inputted by the main board; the output terminal of the constant-current feedback circuit is coupled to the feedback terminal of the first single stage PFC circuit;

the input terminal of the constant-current switch circuit receives direct current, the output terminal of the constant-voltage circuit is coupled to the input terminal of the second transformer, the sampled terminal of the second transformer is coupled to the zero current detection terminal of the second single stage PFC circuit; the output terminal of the second transformer is electrically coupled to the main board.

Preferably, the constant-current feedback circuit turns off the first single stage PFC circuit detecting the LED light bar is not in a working status.

Preferably, the switching power supply further includes the DC-DC conversion circuit, the input terminal of the DC-DC conversion circuit is coupled to the output terminal of the second transformer, the output terminal of the DC-DC conversion circuit is electrically coupled to the main board.

The solution disclosed by the present disclosure has a switching power supply via disposing the constant-current switch circuit, the first single stage PFC circuit, the first transformer, the constant-current feedback circuit, the constant-voltage switch circuit, the second single stage PFC circuit and the second transformer. The present disclosure adopts the output method of single stage PFC without secondary boost conversion. That is, the first single-stage PFC circuit controls the operation of the first transformer, directly converts the AC-DC, outputs the constant-current source, which eliminating the high-voltage electrolytic capacitor, therefore improves the power factor of the power supply and reduces the system cost; meanwhile, a constant-current output circuit includes the constant-current switch, the first single-stage PFC circuit, the first transformer, and the constant-current feedback circuit, and the constant-voltage output circuit includes the constant-voltage switch circuit, the second single-stage PFC circuit, and the second transformer. Therefore, the constant-voltage source and the constant-current source outputted by the switching power supply to be controlled respectively, so that the output of the constant-voltage and the constant-current do not interfere with each other during the dynamic load, and the constant-voltage source is not affected by the crossover of the electrical parameter deviation of the LED light itself, therefore improving the stability of the system.

### BRIEF DESCRIPTION OF THE DRAWINGS

To illustrate the technical solutions according to the embodiment of the present disclosure or in the prior art more clearly, the accompanying drawings for describing the embodiment or the prior art are introduced briefly in the following. Apparently, the accompanying drawings in the following description are only about some embodiment of the present disclosure, and persons of ordinary skill in the art can derive other drawings from the accompanying drawings without creative efforts.

FIG. 1 shows a traditional TV power supply architecture;

FIG. 2 shows a function module diagram of a switching power supply according to an embodiment of the present disclosure;

FIG. 3 shows a function module diagram of a switching power supply according to a further embodiment of the present disclosure;

FIG. 4 shows a structure diagram of a switching power supply according to an embodiment of the present disclosure.

Labels illustration for drawings:

TABLE 1

| Label | Name |
|---|---|
| 1 | constant-current switch circuit |
| 2 | first single stage PFC circuit |
| 3 | constant-current control circuit |
| 31 | starting circuit |
| 32 | constant-current reference source circuit |
| 33 | mirror constant-current circuit |
| 4 | constant-current feedback circuit |
| 5 | constant-voltage switch circuit |
| 6 | second single stage PFC circuit |
| 7 | first secondary rectifier and filter circuit |
| 8 | second secondary rectifier and filter circuit |
| 9 | DC-DC conversion circuit |
| 10 | EMI filter circuit |
| 11 | front stage rectifier and filter circuit |
| WZ1 | first voltage reference chip |
| WZ2 | second voltage reference chip |
| Z1 | first stabilivolt |
| T1 | first transformer |
| T2 | second transformer |
| R1~R25 | first resistor to twenty-fifth resistor |
| D1~D6 | First diode to sixth diode |
| C1~C7 | first capacitor to seventh capacitor |
| Q1~Q8 | first transistor to eighth transistor |
| U1 | first control chip |
| U2 | first optocoupler U2 |
| U3 | second optocoupler |
| U4 | second control chip |
| K1 | first MOS transistor |
| K2 | second MOS transistor |
| M | constant-current switch |
| M1 | first constant-current switch |
| M2 | second constant-current switch |
| VCC1 | first direct current source |
| VDD | second direct current source |

The foregoing objects, features and advantages of the present disclosure will be described in further detail with reference to the accompanying drawings.

### DETAILED DESCRIPTION OF THE EMBODIMENTS

The technical solutions of the embodiments of the present disclosure will now be clearly and completely described in such definite and comprehensive detail with reference to the accompanying drawings. It is obvious that the embodiments to be described are only a part rather than all of the embodiments of the present disclosure. All other embodiments obtained by persons skilled in the art based on the embodiments of the present disclosure without creative efforts shall fall within the protection scope of the present disclosure.

It is to be understood that, all of the directional instructions in the exemplary embodiments of the present disclosure (such as top, down, left, right, front, back) can only be used for explaining relative position relations, moving condition of the elements under a special form (referring to figures), and so on, if the special form changes, the directional instructions changes accordingly.

In addition, the descriptions, such as the “first”, the “second” in the present disclosure, can only be used for describing the aim of description, and cannot be understood as indicating or suggesting relative importance or implicitly indicating the number of the indicated technical character. Therefore, the character indicated by the “first”, the “second” can express or implicitly include at least one character. In addition, the technical proposal of each exemplary embodiment can be combined with each other, however the technical proposal must base on that the ordinary skill in that art can realize the technical proposal, when the combination of the technical proposals occurs contradiction or cannot realize, it should consider that the combination of the technical proposals does not existed, and is not contained in the protection scope required by the present disclosure.

A switching power supply is provided by the present disclosure.

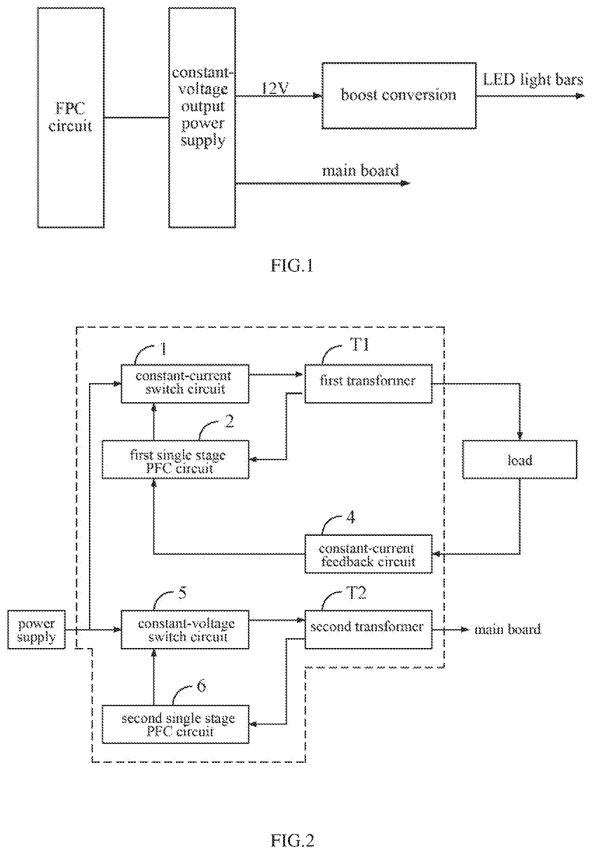

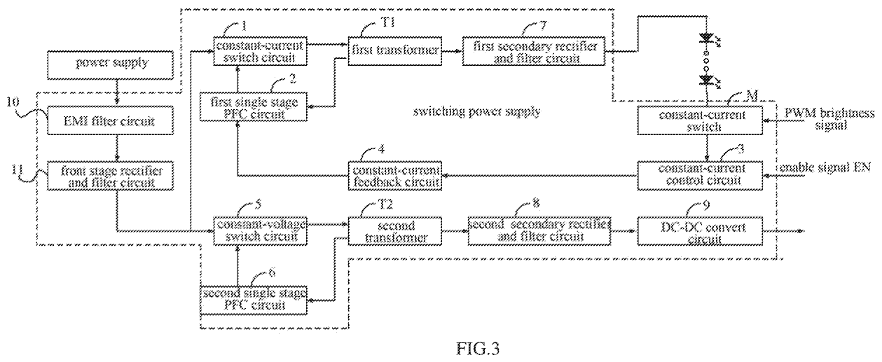

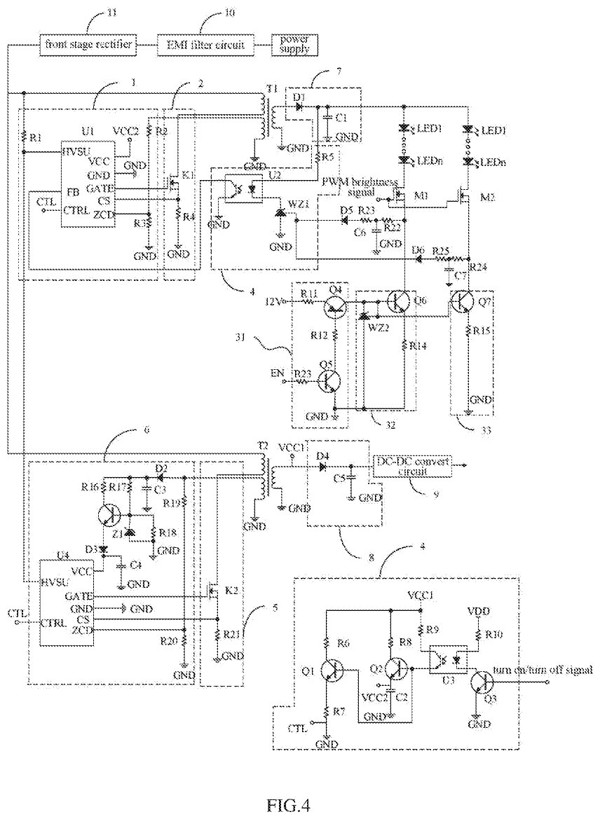

Referring to FIG. 2 and FIG. 3, in the embodiment of the present disclosure, the switching power supply includes a constant-current switch circuit 1, a first single stage PFC circuit 2, a first transformer T1, and a constant-current feedback circuit 4; the switching power supply further including a constant-voltage switch circuit 5, a second single stage PFC circuit 6 and a second transformer T2.

The constant-current feedback circuit 4 samples a current outputted by the first transformer T1, and feeds back the sampled current to the first single stage PFC circuit 2; the first single stage PFC circuit 2 outputs a switch signal, drives the constant-current switch circuit 1 to be turned on or off, and controls the load current to be constant according to the sampled current.

The constant-current switch circuit 1 converts inputted direct current to pulsating direct current power and outputs to the first transformer T1. The first transformer T1 conducts the voltage conversion of the inputted pulsating direct current power and output to the load.

The second single stage PFC circuit 6 outputs a switch signal and drives the constant-current switch circuit 5 to be turned on or off; the second single stage PFC circuit 6 samples a voltage outputted by the second transformer T2 to obtain the sampled voltage, and regulate a duty ratio of the switch signal according to the sampled voltage, to regulate the voltage output to the main board, to control the voltage of the load to be constant.

The constant-voltage switch circuit 5 converts inputted direct current to pulsating direct current power and outputs to the second transformer T2; the second transformer T2 conducts the voltage conversion of the inputted pulsating direct current power and output to the main board.

In the present embodiment, the switching power supply is applied to the television, in which the first transformer supplies power to the LED light bar inside the television, the second transformer supplies power to the main board inside the television.

It should be noted that in the present embodiment, the switching power supply also includes a EMI filter circuit 10 and a front stage rectifier and filter circuit 11. An alternating current outputted by an outer power supply be filtered out electromagnetic disturbance by the EMI filter circuit 10, then be inputted to the front stage rectifier and filter circuit, after being rectified and filtered by the front stage rectifier and filter circuit 11 it is outputted to the first transformer T1.

The first single stage PFC circuit 2 includes a control chip and a corresponding peripheral circuit. In the present embodiment, the control chip adopts the HVLED001A chip of the ST semiconductor, and may automatically control the power switch frequency to enter the working mode of the skip cycle when in standby light load, so as to improve the efficiency of standby light load, eliminate the need for standby transformers and save costs. The constant-current switch M may adopts a MOS transistor, an IGBT, a thyristor or the like, in the present embodiment the MOS transistor is applied.

The solution disclosed by the present disclosure makes a switching power supply via disposes the constant-current switch circuit 1, the first single stage PFC circuit 2, the first transformer T1, the constant-current feedback circuit 4. the present disclosure adopts the output method of single stage PFC without secondary boost conversion. That is, the first single-stage PFC circuit 2 controls the operation of the first transformer T1, directly converts the AC-DC, outputs the constant-current source, which eliminating the high-voltage electrolytic capacitor, therefore improves the power factor of the power supply and reduces the system cost; meanwhile, a constant-current output circuit 1 includes the constant-current switch, the first single-stage PFC circuit 2, the first transformer T1, and the constant-current feedback circuit 4, and the constant-voltage output circuit includes the constant-voltage switch circuit 5, the second single-stage PFC circuit 6, and the second transformer T2. Therefore, the constant-voltage source and the constant-current source outputted by the switching power supply to be controlled respectively, so that the output of the constant-voltage and the constant-current do not interfere with each other during the dynamic load, and the constant-voltage source is not affected by the crossover of the electrical parameter deviation of the LED light itself, therefore improving the stability of the system.

The switching power supply further including a constant-current switch M and a constant-current control circuit 3. The constant-current switch M adjusts the brightness of the LED light bars according to a PWM brightness signal outputted by the main board. The constant-current control circuit 3 controls the LED light bars to be illuminated or extinguished according to an enable signal outputted by the main board.

In the present embodiment, the number of the LED light bar is more than one, during the LED light bars are in a working status, the constant-current control circuit controls current flowing through each LED light bar to be the same, so improves the conformance of the light display.

Specifically, the input terminal of the constant-current circuit 1 receives direct current, the output terminal of the constant-current switch circuit 1 is coupled to the output terminal of the first transformer T1; the sample terminal of the first transformer T1 is coupled to the zero current detection terminal of the first single stage PFC circuit 2; the output terminal of the first transformer T1 is coupled to input terminals of the LED light bars, output terminals of the LED light bars coupled to the input terminal of the constant-current switch, the controlled terminal of the constant-current switch M is coupled to the main board, the output terminal of the constant-current switch M is coupled to the input terminal of the constant current control circuit 3; the output terminal of the constant-current control circuit 3 is coupled to the input terminal of the constant feedback circuit 4, the controlled terminal of the constant-current control circuit 3 receives the enable signal inputted by the main board; the output terminal of the constant-current feedback circuit 4 is coupled to the feedback terminal of the first single stage PFC circuit 2.

The input terminal of the constant-current switch circuit 5 receives direct current, the output terminal of the constant-voltage circuit 5 is coupled to the input terminal of the second transformer T2, the sampled terminal of the second transformer T2 is coupled to the zero current detection terminal of the second single stage PFC circuit 6; the output terminal of the second transformer T2 is electrically coupled to the main board.

In the present embodiment, the zero current detection terminals of the first single stage PFC circuit 2 and the second single stage PFC circuit 6 also respectively coupled to auxiliary windings of the first transformer T1 and the second transformer T2, to detect the zero-crossing point of the current of the voltage, therefore, the corresponding switch tube is controlled to be turned on or off at the zero crossing point to reduce loss and improve power consumption efficiency.

Further, the first single stage PFC circuit 2 regulates a duty ratio of a switch signal according to a feedback level of the optocoupler U2, so as to regulate the current outputted to the LED light bar; the second single stage PFC circuit 6 samples a voltage outputted by the second transformer T2 to obtain the sampled voltage, and regulate a duty ratio of the switch signal according to the sampled voltage, to regulate the voltage output to the main board.

It should be noted that when the voltage of the LED light bar is lower than the voltage outputted by the first transformer T1, the first single stage PFC circuit 2 is controlled by the constant-current feedback circuit 4, and the operating frequency or duty ratio of the first single stage PFC circuit 2 is regulated, the constant-current switching circuit 1 is further controlled to smaller the voltage outputted by the flyback transformer, so that the voltage outputted by the first transformer T1 may matches the operating voltage of the LED light bar, therefore reduce the temperature rise of the constant-current control circuit 3. The problem of large difference in output voltage caused by large voltage deviation of the same screen LED light in mass production is solved.

The first single stage PFC circuit 2 also makes the voltage of the auxiliary winding constant through the auxiliary winding of the first transformer T1, therefore limiting the voltage outputted by the first transformer T1 within a prescribed range.

The constant-voltage switch circuit 5 further controls the second transformer T2 under the control of current of the second single stage PFC, and after rectifying and filtering outputs a stable constant-voltage source. The constant-voltage feedback loop is a primary side feedback, that is, the voltage of the auxiliary winding is constant through the auxiliary winding of the second transformer T2, so that the voltage outputted by the second transformer T2 is constant.

Further, the switching power supply further includes a first secondary rectifier and filter circuit 7 and a second secondary rectifier and filter circuit 8; the first secondary rectifier and filter circuit 7 rectifies and filters a pulsating direct current outputted by the first transformer T1; the second secondary rectifier and filter circuit 8 rectifies and filters a pulsating direct current power outputted by the second transformer T2.

In order to further improve the efficiency of the switching power supply, when the constant-current feedback circuit 4 detecting the LED light bar is off, that is, the LED light bar is detected not in a working status, the constant-current feedback circuit 4 turns off the first single stage PFC circuit 2, therefore reducing the loss of the first single stage PFC circuit 2.

When the load requires high ripple, the DC-DC conversion circuit may be added to the output, to make the output voltage low frequency ripple smaller. Therefore the switching power supply further includes the DC-DC conversion circuit 9, an input terminal the DC-DC conversion circuit 9 is coupled to an output terminal of the second secondary rectifier and filter circuit 8, an output terminal of the DC-DC conversion circuit 9 is electrically coupled to the main board.

When the LED light bars driven by the switching power supply are in plurality of groups, it is easy to understand that the switching power supply includes a plurality of constant-current switches M correspondingly, the input terminals and the output terminals of the plurality of constant-current switches M are respectively coupled in series between the output terminals of the light bars and the input terminal of the constant-current control circuit 3, the controlled terminals of the plurality of constant-current switches M receive the PWM brightness signal outputted by the main board.

The constant-current control circuit 3 includes a starting circuit 31, a constant-current reference source circuit 32, and a plurality of mirror constant-current circuits; the output terminal of the starting circuit 33 is coupled to the main board to receive the enable signal; the output terminal of the starting circuit 31 is coupled to the controlled terminal of the constant-current reference source circuit 32, the input terminal of the constant-current reference source circuit 32 is coupled to the output terminal of one of the LED light bars; all controlled terminals of the mirror constant-current circuits are coupled to the output terminal of the constant-current reference source circuit 32, input terminals of the mirror constant-current circuits are coupled to output terminals of other LED light bars respectively.

It should be noted that the enable signal sent by the main board includes an enable signal and a shutdown signal. When the starting circuit 31 receives the turn-on signal, the starting circuit 31 outputs a high level, the constant-current reference source circuit 32 is turned on, and the constant-current reference source circuit 32 supplies a current reference for each of the mirror constant-current circuits 33 of the subsequent stage, and each mirror constant-current circuits 33 of the subsequent stage replicates the current in the constant-current reference source circuit 32, so as to equal the current of each of the mirror constant-current circuits 33 and the current of the constant-current reference source circuit 32, so that the brightness of each LED bar skip to shift.

Further, the switching power supply further includes an over-voltage regulation circuit (not shown), in which the number of the over-voltage regulation circuits corresponds to the number of LED bars. Each input terminal of the over-voltage regulation circuit is coupled to the corresponding output terminal of the constant-current switch M, all output terminals of the over-voltage regulation circuits coupled to the regulation terminal of the constant-current feedback circuit 4. The over-voltage regulation circuit controls the first single stage PFC circuit 2 through the constant-current feedback circuit 4 when the output voltage of the transformer is detected to be exceed the voltage of the LED light bars, regulates the switching frequency of the first MOS transistor, and reduces the outputted voltage of the transformer to the LED light bars.

The constant-current method of the present disclosure is controlled by the series constant-current reference source circuit 32, so that the current flowing through the LED bar is constant, and when the ripple is large, the constant-current reference source circuit 32 may automatically regulate the voltage division to reduce the current ripple, when the difference of the voltage difference of the LED light bar is large, the voltage difference of the LED light bar is too large, and the first single-stage PFC circuit 2 of the primary side is controlled by the regulation of the over-voltage, so as to lowering the output voltage and the voltage across the constant-current source is lowered.

Referring to FIG. 3, the present disclosure will be further described in conjunction with a specific circuit diagram of the switching power supply:

The first transformer T1 includes a primary winding, a secondary winding and an auxiliary winding, in which the auxiliary winding is disposed at a primary of the transformer;

the first single stage PFC circuit 2 includes a first resistor R1, a second resistor R2, a third resistor R3, and a first control chip U1; the constant-current switching circuit 1 includes a first MOS transistor K1 and a fourth resistor R4; The first control chip U1 includes an over-voltage protection terminal HVSU, a power terminal VCC, a driver terminal GATE, a ground terminal GND, an over-current detection terminal CS, a zero-cross detection terminal ZCD, a feedback terminal FB, and a control terminal CTRL;

a first terminal of the first resistor R1 is coupled to an output terminal of the front stage rectifier and filter circuit 11, a second terminal of the first resistor R1 is coupled to an over-voltage protection terminal of the first control chip U1; a first terminal of the auxiliary winding of the first transformer T1 is coupled to a first terminal of the second resistor R2, a second terminal of the second resistor R2 is coupled to a first terminal of the third resistor R3, a second terminal of the third resistor R3 is grounded, a second terminal of the auxiliary winding of the first transformer T1 is grounded, a zero-cross detection terminal of the first control chip U1 is coupled to a first terminal of the third resistor R3; a first terminal of a primary coil of the first transformer T1 is coupled to an output terminal of the front stage rectifier and filter circuit, a second terminal of the primary coil of the first transformer T1 is coupled to the drain of the first MOS transistor K1, a source of the first MOS transistor K1 is grounded through the fourth resistor R4, a gate of the first MOS transistor K1 is coupled to a driver terminal of the first control chip U1, a zero-cross detection terminal of the first control chip U1 is coupled to the source of the first MOS transistor K1, and a ground terminal of the first MOS terminal is grounded.

The first rectifier and filter circuit 7 includes a first diode D1 and a first capacitor C1; an anode of the first diode D1 is coupled to a first terminal of the secondary winding, and a cathode of the first diode D1 is coupled to a first terminal of the LED bar, the second terminal of the secondary winding is grounded; a first terminal of the first capacitor C1 is coupled to the cathode of the first diode D1, and a second terminal of the first capacitor C1 is grounded.

The constant-current feedback circuit 4 includes a fifth resistor R5, a sixth resistor R6, a seventh resistor R7, an eighth resistor R8, a ninth resistor R9, a tenth resistor R10, a first optocoupler U2, a second optocoupler U3, a first voltage reference chip WZ1, a first transistor Q1, a second transistor Q2, a third transistor Q3, a second capacitor C2, a first direct current source VCC1, and a second direct current source VDD; in the present embodiment the first direct current source VCC1 is supplied by the voltage outputted by the second transformer T2. It should be noted that the side of the photocoupler provided with the illuminator is the control side. The side with the light receiver is the executive side.

A first terminal of the fifth resistor R5 is coupled to the cathode of the first diode D1, a second terminal of the fifth resistor R5 is coupled to an input terminal in the control side of the first optocoupler U2, an output terminal in the control side of the first optocoupler U2 coupled to the input terminal of the first voltage reference chip WZ1, an output terminal of the first voltage reference chip WZ1 is grounded, a reference terminal of the first voltage reference chip WZ1 is coupled to an output terminal of the constant-current switch M; an input terminal in the executive side of the first optocoupler U2 is grounded, and an output terminal in the executive side of the first optocoupler U2 is coupled to a feedback terminal of the first control chip U1.

A first terminal of the sixth resistor R6 is coupled to a first direct current source VCC1, a second terminal of the sixth resistor R6 is coupled to a collector of the first transistor Q1, an emitter of the first transistor Q1 is grounded through the seventh resistor, a base of the first transistor Q1 is coupled to a base of the second transistor Q2; a first terminal of the eighth resistor R8 is coupled to the first direct current source VCC1, a second terminal of the eighth resistor R8 is coupled to a collector of the second transistor Q2, an emitter of the second transistor Q2 is grounded via the second capacitor C2; a first terminal of the ninth resistor R9 is coupled to the first direct current source VCC1, a second terminal of the ninth resistor R9 is coupled to an execution input terminal of the second photocoupler U3, an execution output terminal of the second photocoupler U3 is coupled to the base of the second transistor Q2; an input terminal in control side of the second optocoupler U3 is coupled to the second direct current source VDD via the tenth resistor R10, an output terminal in the control side of the second photocoupler U3 is coupled to a collector of the third transistor Q3, an emitter of the third transistor Q3 is grounded, a base of the third transistor Q3 is electrically coupled to the main board to receive the power-on signal and shutdown signal outputted by the main board.

In the present embodiment, the two LED bars are taken as an example for description, the constant-current switch M includes a first constant-current switch M1 and a second constant-current switch M2; an input terminal of the first constant-current switch M1 is coupled to an output terminal of one of the LED light bars, an output of the first constant-current switch M1 is coupled to an input terminal of the constant-current reference source circuit 32, an input terminal of the second constant-current switch M2 is coupled to an output terminal of another LED light bar, an output terminal of the constant-current switch M2 is coupled to an input terminal of the constant-current reference source circuit 32, an controlled terminal of the first constant-current switch M1 and an controlled terminal of the second constant-current switch M2 are electrically coupled to the main board to receive the PWM brightness signal outputted by the main board.

The starting circuit 31 includes an eleventh resistor R11, a twelfth resistor R12, a thirteenth resistor R13, a fourth triode Q4, a fifth triode Q5;

a first terminal of the eleventh resistor R11 is coupled to 12V direct current power supply, a second terminal of the eleventh resistor R11 is coupled to an emitter of the fourth triode Q4, a collector of the fourth triode Q4 is coupled to the controlled terminal of the constant-current reference source circuit 32, a base of the fourth triode Q4 is coupled to a collector of the fifth triode Q5 via the twelfth resistor R12, an emitter of the fifth triode Q5 is grounded, a base of the fifth triode Q5 is coupled to the main board via the thirteenth resistor R13, to receive the enable signal EN of the main board.

The constant-current reference source circuit 32 includes a fourteenth resistor R14, a second voltage reference chip WZ2, a sixth triode Q6; an input terminal of the second voltage reference chip is coupled to a collector of the fourth triode Q4, an output terminal of the second voltage reference chip is grounded; a reference terminal of the second voltage reference chip WZ2 is coupled to controlled terminals of the mirror constant-current circuits, and the reference terminal of the second voltage reference chip WZ2 also coupled to a base of the sixth triode Q6, the base of the sixth triode Q6 also coupled to the collector of the fourth triode Q4, a collector of the sixth triode Q6 is coupled to output terminals of the first constant-current switch M1, an emitter of the sixth triode Q6 is grounded via the fourteenth transistor.

The mirror constant-current circuit 33 includes fifteenth resistor R15, a seventh triode Q7; a collector of the seventh triode Q7 is coupled to an output terminal of second constant-current switch M2, an emitter of the seventh triode Q7 is grounded via the fifteenth resistor R15.

The second single stage PFC circuit 6 includes a sixteenth resistor R16, a seventeenth resistor R17, an eighteenth resistor R18, a nineteenth resistor R19, a twentieth resistor R20, a third capacitor C3, and a second diode D2, a third diode D3, an eighth transistor Q8, a first stabilivolt Z1, a fourth capacitor C4, and a second control chip U4; the second transformer T2 includes a primary winding, a secondary winding, and the auxiliary winding, in which the auxiliary winding is disposed at the primary of the transformer; the second control chip U4 includes an over-voltage protection terminal HVSU, a power terminal VCC, a driver terminal GATE, a ground terminal GND, an over-current detection terminal CS, a zero-cross detection terminal ZCD, and a control terminal CTRL.

A first terminal of the sixteenth resistor R16 is coupled to a cathode of the second diode D2, an anode of the second diode D2 is coupled to a first terminal of the auxiliary winding of the second transformer T2, a second terminal of the auxiliary winding is grounded, a second terminal of the sixteen resistor R16 is coupled to a collector of the eighth transistor Q8, an emitter of the eighth transistor Q8 is coupled to an anode of the third diode D3, a cathode of the third diode D3 is coupled to a power terminal of the second control chip U4, a first terminal of the fourth capacitor C4 is coupled to a cathode of the third diode D3, a second terminal of the fourth capacitor C4 is grounded, a base of the eighth transistor Q8 is coupled to a cathode of the second diode D2 via the seventh resistor R17; a first terminal of the third capacitor C3 is coupled to a cathode of the second diode D2, a second terminal of the third capacitor C3 is grounded; an anode of the first stabilivolt Z1 is coupled to a base of the eighth transistor Q8, a cathode of the first stabilivolt Z1 is grounded, a first terminal of the eighteenth resistor R18 is coupled to a base of the eighth transistor Q8, a second terminal of the eighteenth resistor R18 is grounded; an over-voltage protection terminal of the second control chip U4 is coupled to a second terminal of the first resistor R1, a ground terminal of the second control chip U4 is grounded; a first terminal of the ninth resistor R19 is coupled to an anode of the second diode D2, a second terminal of the nineteenth resistor R19 is grounded via the twentieth resistor R20; a zero-cross detection terminal of the second control chip U4 is coupled to a second terminal of the nineteenth resistor R19.

The constant-current switch circuit 1 includes a second eleventh resistor R21 and a second MOS transistor K2; a first terminal of the second winding of the second transformer T2 is coupled to an output terminal of the front stage rectifier and filter circuit, a drain of the second MOS transistor K2 is coupled to a second terminal of the primary winding of the second transformer T2, a source of the second MOS transistor is grounded via the second eleventh resistor R21, a gate of the second MOS transistor K2 is coupled to the driver terminal of the second control chip U4, an over-current detection terminal of the second control chip U4 is coupled to a source of the second MOS transistor K2.

The second rectifier and filter circuit 8 includes a fourth diode D4 and a fifth capacitor C5, an anode of the fourth diode D4 is coupled to a first terminal of the secondary winding of the second transformer T2, a second terminal of the secondary winding is grounded, a cathode of the fourth diode D4 is coupled to an input terminal of the DC-DC conversion circuit 9, and is outputted to the main board after voltage conversion.

The over-voltage regulation circuit includes a first over-voltage regulation circuit (not shown) and a second over-voltage regulation circuit (not shown), the first over-voltage regulation circuit includes a twenty-second resistor R22, a twenty-third resistor R23, a fifth diode D5 and a sixth capacitor C6; the second over-voltage regulation circuit includes a twenty-fourth resistor R24, a twenty-fifth resistor R25, a sixth diode D6 and a seventh capacitor C7; in which a cathode of the fifth diode D5 is coupled to the voltage reference terminal of the first voltage reference chip WZ1, an anode of the fifth diode D5 is coupled to a first terminal of the twenty-fourth resistor R24 via the twenty-third resistor R23, a second terminal of the fourteenth resistor is coupled to an output terminal of the first constant-current switch M1, a first terminal of the sixth capacitor C6 is coupled to a first terminal of the twenty-second resistor R22, and a second terminal of the sixth capacitor C6 is grounded.

An cathode of the sixth diode D6 is coupled to the voltage reference terminal of the first voltage reference chip WZ1, and anode of the sixth diode D6 is coupled to the first terminal of the second sixteenth resistor via the twenty-fifth resistor R25, a second terminal of the twenty-sixth resistor is coupled to an output terminal of the first constant-current switch M1, a first terminal of the seventh capacitor C7 is coupled to a first terminal of the twenty-fourth resistor R24, a second terminal of the seventh capacitor C7 is grounded.

Continuing referring to FIG. 2, the power supply is supplied to the first transformer T1 and the second transformer T2 respectively after processed by the EMI filter circuit 10 and the front stage rectifier and filter circuit 11, large electrolytic capacitor filtering is no need, the transformer is further controlled by the first MOS transistor K1 and the second MOS transistor K2 under the control of the respective control chip, so that the first transformer T1 supplies power to the LED light bars after processed by the first secondary rectifier and filter circuit 7; the second transformer T2 supplies power to the main board after processed by the second secondary rectifier and filter circuit 8. The above single stage PFC controls the constant-current switching circuit 1 and the constant-voltage switching circuit 5, and further controls the first converter and the second transformer T2 respectively, so that the design does not require a high voltage electrolytic capacitor, therefore saving the area and costs of the PCB. As the constant-current source outputted by the first transformer T1 and the constant-voltage source outputted by the second transformer T2 to be controlled respectively, the output of the constant-voltage and the constant-current do not interfere with each other during the dynamic load, and the constant-voltage is not affected by the crossover of the electrical deviation of the LED light, therefore improving the stability of the system.

When the power-on signal is at a high level, the third transistor Q3 is turned on, the second transistor Q2 is turned on by the second photocoupler U3, the first direct current source VCC1 is outputted to a power terminal of the first control chip U1 through the eighth resistor R8 to supplies power to the first control chip U1, meantime the first transistor Q1 is turned on, the voltage is sampled by the sixth resistor R6 and the seventh resistor R7, and then coupled to the control terminal of the first control chip U1, so that the control chip U1 starts to operate. In addition, when the enable signal EN is at a high level, the constant-current reference source circuit 32 starts to operate, the sixth triode Q6 is turned on, and a current flows through the LED light bar and in an illuminated state. The brightness of the LED light bar is adjusted by the PWM bright spot signal outputted by the main board, specifically by controlling the turn-on time of the first constant-current switch M1 to adjust the brightness of the LED light bar, when the duty ratio of the PWM brightness signal is large, the LED light bar is brighter, when the duty ratio of the PWM brightness signal is small, the LED light bar is dark.

When the enable signal EN is at a low level, the constant-current reference source circuit 32 is not operate, the sixth triode Q6 is turned off, no current flows through the LED light bar and in a extinguished state.

When the output signal of the main board is at a low level, the third transistor Q3 is turned off, the second transistor Q2 is turned off by the second photocoupler U3, the power supply of the second control chip U4 is turned off, meantime the first transistor Q1 is turned off, the control terminal of the first control chip U1 stops operating after the seventh resistor is pulled low, at this time, the output of the constant-current of the switching power supply stops operating, so that the standby power consumption is low.

Further, the constant-current control circuit 3 is controlled by a series constant-current reference source, constant-current reference source circuit 32 is include by the second voltage reference chip WZ2, the sixth triode Q6 and the fourteenth resistor R14, the second voltage reference chip WZ2 supplies a reference voltage to the constant-current, and the sixth triode Q6 is controlled, so that the voltage across the fourteenth resistor R14 is constant, further the current flowing through the LED light bar is constant. When the output voltage ripple of the first transformer T1 is large, since the sixth triode Q6 operates in the amplification region, the second voltage reference chip WZ2 controls the sixth triode Q6 to automatically regulate the voltage division of the collector and the emitter, which makes the current more precise and reduces the current ripple. When the voltage of the LED light bar is too small, due to the constant output voltage of the first transformer T1 is constant, the voltage of the collector of the sixth triode Q6 increases, and passes through the second over-voltage regulation circuit included by the twenty-fourth resistor R24, the seventh capacitor C7, the twenty-fifth resistor R25 and the sixth diode D6, the current flowing through the first photocoupler U2 is controlled through the first voltage reference chip WZ1, therefore controlling the operating frequency of the first control chip U1, further the output voltage of the first transformer T1 is lowered, so that the voltage between the collector and the emitter of the sixth triode Q6 is lowered.

Another mirror constant-current circuit 33 includes a seventh triode Q7 and a fifteenth resistor R15, the mirror constant-current circuit 33 uses the constant-current reference source circuit 32 as a current mirror body with, so that the currents of the constant-current circuit and the current mirror body are the same, the subsequent stage may copy any of the same constant current sources, so that the constant current output may match LED light bars with any number of channels.

Further, after the switching power supply is powered on, the rectified and filtered voltage passes through the first resistor R1 to pre-activate the over-voltage protection terminals of the first control chip U1 and the second control chip U4, so as to the voltage of the respective power terminals may reach the turn-on voltage, the first control chip U1 and the second control chip U4 start to oscillate. After stabilization, the auxiliary winding of the secondary transformer T2 outputs voltage, which passes through the eighth transistor Q8, the third diode D3, the sixteenth resistor R16, the seventeenth resistor R17, the first stabilivolt Z1, and the eighteenth resistor R18, and constitutes a linear regulator circuit of the power supply of the second control chip U4, to provide a stable operating voltage for the second control chip U4.

At the same time, the over-voltage protection terminal of the first control chip U1 and the second control chip U4 detects the full-wave voltage signal of the rectified and filtered voltage as a reference signal, and respectively detects the current of the primary winding via sampling the current that through the current sampling resistor, that is, the fourth resistor R4 and the second eleventh resistor R21, to compare with the reference signal, so as to control the operating frequency and duty ratio of the first MOS transistor K1 and the second MOS transistor K2, when the full-wave voltage is large, the operating frequency is high, and the duty ratio is small; when the full-wave voltage is small, the operating frequency is low, and the duty ratio is high, therefore the full-wave voltage signal and the current flowing through the primary winding of the corresponding transformer are in phase, and finally improves the power factor, and the AC-DC conversion is also realized.

Further, as described above, the constant-current source for supplying power to the LED light bars and the constant-voltage source for supplying power to the main board are separately controlled, therefore reducing the rise of working temperature of the first transformer T1, the second transformer T2, the first MOS transistor K1, and the second MOS transistor K2, and also improves the stability of the independent control of the system. Further, when the voltage of the LED light bar is smaller than the voltage outputted by the secondary winding of the first transformer T1, the constant-current control circuit 3 further controls the first MOS transistor K1 by smaller the operating frequency and duty ratio of the first control chip U1, so the voltage outputted by the first transformer T1 become smaller, so that the voltage output by the first transformer T1 and the operating voltage of the LED light bar is matched, which in turn reduces the temperature rise of the constant-current control circuit 3. The problem of large difference in output voltage caused by large voltage deviation of the same screen LED light in mass production is solved. The fifth resistor R5 serves as a current limiting resistor of the first photocoupler U2, the fourth resistor R4 samples the current in the primary winding and is coupled to the over-current detection terminal of the first control chip U1, when the output power is too large, the voltage sampled at the fourth resistor R4 is greater than the inner reference of the over-current detection terminal of the first control chip U1, to start the overload protected of the first control chip U1. The Sampling resistor of the second resistors R2 and the third resistor R3 sample the voltage of the auxiliary winding of the transformer, to limit the voltage of the auxiliary winding in the safe range, so the voltage output from the first transformer T1 is prevented from being excessively large.

Further, the second MOS transistor K2 further controls the second transformer T2 under the control of the second single-stage PFC circuit 6, rectified by the fourth diode D4, and after filtered by the fourth capacitor, outputs a stable constant voltage source. The constant voltage feedback loop is the primary side feedback, that is, the sampling resistor of the nineteenth resistor R19 and the twentieth resistor R20 sample the voltage of the auxiliary winding of the second transformer T2, so that the voltage of the auxiliary winding is constant, and the output voltage is constant, when the ripple requirement is high, the DC-DC conversion circuit may be added at the output to make the output voltage ripple smaller.

It should be noted that the mirror constant-current circuit 33 may be arbitrarily expanded according to the number of channels of the LED light bar, so that the solution achieves the requirement of matching any number of LED light bar channel, and realizes the design of the large-size TV power supply to be low cost and high power factor.

There is also provided a television that includes LED light bars, a main board and the switching power supply as described above, the switching power supply having particular arrangements described in the above embodiments, because the television employs all of the features of the above embodiments, all of the advantages of the above embodiments are present here and are not to be repeated herein.

The switching power supply is respectively electrolyzed with the LED light bar and the main board, to provide a constant-current source and a constant-voltage source respectively. The main board also electrically coupled to the LED light bars to control the brightness of the LED light bars.

The foregoing description merely depicts some exemplary embodiments of the present disclosure and therefore is not intended as limiting the scope of the disclosure. Any equivalent structural transformations made to the disclosure, or any direct or indirect applications of the disclosure on any other related fields based on the concepts of the present disclosure, shall all fall in the scope of the disclosure.

1. A switching power supply, comprising:
a constant-current switch circuit, a first single stage PFC circuit, a first transformer, and a constant-current feedback circuit; the switching power supply further comprising a constant-voltage switch circuit, a second single stage PFC circuit, and a second transformer; wherein
the constant-current feedback circuit samples a current outputted by the first transformer, and feeds back the sampled current to the first single stage PFC circuit;
according to the sampled current, the first single stage PFC circuit outputs a switch signal, drives the constant-current switch circuit to be turned on or off, and controls a load current to be constant; and
the second single stage PFC circuit outputs a switch signal and drives the constant-current switch circuit to be turned on or off; the second single stage PFC circuit samples a voltage outputted by the second transformer to obtain the sampled voltage, and regulate a duty ratio of the switch signal according to the sampled voltage, to regulate the voltage output to a main board, to control the voltage of the main board to be constant.

2. The switching power supply according to claim 1, further comprising a constant-current switch and a constant-current control circuit, wherein the load is LED light bars,
the constant-current switch adjusts the brightness of the LED light bars according to a PWM brightness signal outputted by the main board; and
the constant-current control circuit controls the LED light bars to be illuminated or extinguished according to an enable signal outputted by the main board.

3. The switching power supply according to claim 2, wherein the constant-current control circuit controls current flowing through each LED light bar to be the same during the LED light bars are in a working status.

4. The switching power supply according to claim 1, wherein an input terminal of the constant-current switch circuit receives direct current, an output terminal of the constant-current switch circuit is coupled to an input terminal of the first transformer; a sample terminal of the first transformer is coupled to a zero current detection terminal of the first single stage PFC circuit; the output terminal of the first transformer is coupled to input terminals of the LED light bars, output terminals of the LED light bars are coupled to an input terminal of the constant-current switch, a controlled terminal of the constant-current switch is coupled to the main board, an output terminal of the constant-current switch is coupled to an input terminal of the constant current control circuit; an output terminal of the constant-current control circuit is coupled to an input terminal of the constant feedback circuit, an controlled terminal of the constant-current control circuit receives the enable signal inputted by the main board; an output terminal of the constant-current feedback circuit is coupled to a feedback terminal of the first single stage PFC circuit;
the input terminal of the constant-current switch circuit receives direct current, an output terminal of the constant-voltage circuit is coupled to an input terminal of the second transformer, a sampled terminal of the second transformer is coupled to a zero current detection terminal of the second single stage PFC circuit; an output terminal of the second transformer is electrically coupled to the main board.

5. The switching power supply according to claim 2, wherein the constant-current feedback circuit turns off the first single stage PFC circuit when detecting that the LED light bar is not in a working status.

6. The switching power supply according to claim 5, wherein the switching power supply further comprises a DC-DC conversion circuit, an input terminal of the DC-DC conversion circuit is coupled to the output terminal of the second transformer, an output terminal of the DC-DC conversion circuit is electrically coupled to the main board.

7. The switching power supply according to claim 6, wherein the constant-current control circuit comprises a starting circuit, a constant-current reference source circuit, and a plurality of mirror constant-current circuits; an output terminal of the starting circuit is coupled to the main board to receive the enable signal; an output terminal of the starting circuit is coupled to a controlled terminal of the constant-current reference source circuit, an input terminal of the constant-current reference source circuit is coupled to an output terminal of one of the LED light bars; all controlled terminals of the mirror constant-current circuits are coupled to an output terminal of the constant-current reference source circuit, input terminals of the mirror constant-current circuits are coupled to output terminals of the other LED light bars respectively.

8. The switching power supply according to claim 7, wherein the starting circuit comprises an eleventh resistor, a twelfth resistor, a thirteenth resistor, a fourth triode, a fifth triode;
a first terminal of the eleventh resistor is coupled to a direct current power supply, a second terminal of the eleventh resistor is coupled to an emitter of the fourth triode, a collector of the fourth triode is coupled to the controlled terminal of the constant-current reference source circuit, a base of the fourth triode is coupled to a collector of the fifth triode via the twelfth resistor, an emitter of the fifth triode is grounded, a base of the fifth triode is coupled to the main board via the thirteenth resistor, to receive the enable signal of the main board.

9. The switching power supply according to claim 8, wherein the constant-current reference source circuit comprises a fourteenth resistor, a second voltage reference chip, a sixth triode; an input terminal of the second voltage reference chip is coupled to a collector of the fourth triode, an output terminal of the second voltage reference chip is grounded; a reference terminal of the second voltage reference chip is coupled to controlled terminals of the mirror constant-current circuits, and the reference terminal of the second voltage reference chip also coupled to a base of the sixth triode, the base of the sixth triode also coupled to the collector of the fourth triode, a collector of the sixth triode is coupled to input terminals of the LED light bars, an emitter of the sixth triode is grounded via the fourteenth transistor;
the mirror constant-current circuit comprises a fifteenth resistor, a seventh triode; a collector of the seventh triode is coupled to an output terminal of another LED light bar, an emitter of the seventh triode is grounded via the fifteenth resistor.

10. The switching power supply according to claim 9, further comprising over-voltage regulation circuits, wherein the number of the over-voltage regulation circuits corresponds to the number of the LED light bars; each input terminal of the over-voltage regulation circuits is coupled to a corresponding output terminal of the constant-current switch, all output terminals of the over-voltage regulation circuits are coupled to a regulation terminal of the constant-current feedback circuit.

11. The switching power supply according to claim 1, wherein further comprises a first secondary rectifier and filter circuit and a second secondary rectifier and filter circuit; the first secondary rectifier and filter circuit rectifies and filters a pulsating direct current outputted by the first transformer; the second secondary rectifier and filter circuit rectifies and filters a pulsating direct current outputted by the second transformer.

12. A television, comprising LED light bars and a main board, and further comprising a switching power supply, the switching power supply being electrically coupled to the LED light bars and the main board separately, the main board being also electrically coupled to the LED light bars, wherein the switching power supply comprises:
a constant-current switch circuit, a first single stage PFC circuit, a first transformer, and a constant-current feedback circuit; the switching power supply further comprising a constant-voltage switch circuit, a second single stage PFC circuit, and a second transformer; wherein
the constant-current feedback circuit samples a current outputted by the first transformer, and feeds back the sampled current to the first single stage PFC circuit;
according to the sampled current, the first single stage PFC circuit outputs a switch signal, drives the constant-current switch circuit to be turned on or off, and controls a load current to be constant; and
the second single stage PFC circuit outputs a switch signal and drives the constant-current switch circuit to be turned on or off; the second single stage PFC circuit samples a voltage outputted by the second transformer to obtain the sampled voltage, and regulate a duty ratio of the switch signal according to the sampled voltage, to regulate the voltage output to a main board, to control the voltage of the main board to be constant.

13. The television according to claim 12, wherein the switching power supply further comprises a constant-current switch and a constant-current control circuit, wherein the load is LED light bars,
the constant-current switch adjusts the brightness of the LED light bars according to a PWM brightness signal outputted by the main board; and
the constant-current control circuit controls the LED light bars to be illuminated or extinguished according to an enable signal outputted by the main board.

14. The television according to claim 13, wherein the constant-current control circuit controls current flowing through each LED light bar to be the same during the LED light bars are in a working status.

15. The television according to claim 12, wherein an input terminal of the constant-current circuit receives direct current, an output terminal of the constant-current switch circuit is coupled to an input terminal of the first transformer; a sample terminal of the first transformer is coupled to a zero current detection terminal of the first single stage PFC circuit; the output terminal of the first transformer is coupled to input terminals of the LED light bars, output terminals of the LED light bars are coupled to an input terminal of the constant-current switch, a controlled terminal of the constant-current switch is coupled to the main board, an output terminal of the constant-current switch is coupled to an input terminal of the constant current control circuit; the output terminal of the constant-current control circuit is coupled to the input terminal of the constant feedback circuit, the controlled terminal of the constant-current control circuit receives the enable signal inputted by the main board; the output terminal of the constant-current feedback circuit is coupled to the feedback terminal of the first single stage PFC circuit; the input terminal of the constant-current switch circuit receives direct current, the output terminal of the constant-voltage circuit is coupled to the input terminal of the second transformer, the sampled terminal of the second transformer is coupled to the zero current detection terminal of the second single stage PFC circuit; the output terminal of the second transformer is electrically coupled to the main board.

16. The television according to claim 13, wherein the constant-current feedback circuit turns off the first single stage PFC circuit when detecting that the LED light bar is not in a working status.

17. The television according to claim 16, wherein the switching power supply further comprises a DC-DC conversion circuit, the input terminal of the DC-DC conversion circuit is coupled to the output terminal of the second transformer, the output terminal of the DC-DC conversion circuit is electrically coupled to the main board.
